(19) United States
(12) Patent Application Publication
(10) Pub. No.: US 2006/0032774 A1
(43) Pub. Date: Feb. 16, 2006

(54) Package for storing goods in a preservative state as well as a method for making such a package

(76) Inventors: Henry Norrby, Ojevagen (SE); Mats Nygardh, Myra (SE)

Correspondence Address: YOUNG & THOMPSON, 745 SOUTH 23RD STREET, 2ND FLOOR, ARLINGTON, VA, 22202, US

(21) Appl. No.: 10/538,003

(22) PCT Filed: Dec. 2, 2003
(86) PCT No.: PCT/SE03/01863

§ 371 Date: Jun. 3, 2005

(30) Foreign Application Priority Data
Dec. 3, 2002 (SE) 0203566-5
Apr. 16, 2003 (SE) 0301125-1
Apr. 16, 2003 (SE) 0301126-9

(51) Int. Cl. B65D 85/00; G01D 21/00

(52) U.S. Cl. 206/459.1; 116/207

(57) ABSTRACT

The invention relates to a package for goods having a bar-code (2) and a temperature indicator (3) including a contrast medium between a front wall and a base wall. According to the invention, the temperature indicator (3) is placed beside the bar-code (2) in close vicinity of an outer code bar (4) thereof without covering the bar-code, in order to, on one hand, in a first temperature state without hindrance enable scanning of the bar-code, but, on the other hand, after a colour alteration in the contrast medium make scanning impossible, more precisely by making an outer neutral field (5) opaque. The invention also relates to a method for marking packages.

### TECHNICAL FIELD

In a first aspect, this invention relates to a package for storing goods in a preservative state in which the temperature may not pass a certain limit value, comprising, on one hand, a bar-code of the type that between two outer, light-absorbing code bars includes a plurality of intermediate and likewise light-absorbing code bars or marks mutually spaced-apart by neutral, light-reflecting fields, outer, neutral fields being found, also outside the outer code bars, and on the other hand a temperature indicator, which comprises a contrast medium contained between two walls, which medium in a first temperature state is transparent or light-reflecting, but which on transition to another temperature state is triggered so far that the same is irreversibly converted to an opaque or light-absorbing colour.

### BACKGROUND ART

Deep-frozen foods are handled in large amounts in the food sector. During the period between the production, when the goods are deep-frozen, and the retail sale to the final consumer, it is of vital importance that the temperature of the package and the goods contained in the same does not exceed a certain recommended desired value, which for deep-frozen products usually is −18° C. If the goods during a certain time would unintentionally obtain a higher temperature than the recommended desired value, there is a risk that the quality of the goods is deteriorated, and if the exposure to the higher temperature would become long, the goods may become directly unhealthy by growth of bacteria. The handling of the goods from the producer to the consumer includes, in practice, a plurality of different phases, such as storage (long-term as well as short-term storage), transshipments, transports, as well as handling in the shop. There are, per se, strict rules and recommendations how the temperature of the goods should be supervised and documented during these different steps, but in practice the rules are difficult to completely observe. If the individual goods at some point, by misadventure or otherwise, would be exposed to a higher temperature than the recommended highest desired value, neither the consumers nor other parties in the chain between the producer and the consumer have previously been able to see this on the proper package.

With the purpose of managing the above-mentioned problems, it has by WO 01/72601 been proposed to provide packages for frozen goods with a temperature indicator, which comprises a means, which has a certain property when the temperature of the goods is lowered towards and past a predetermined limit value, which is at least somewhat higher than the desired value of temperature of the goods in question, but which alters said property in an irreversible way if the temperature during the storage would rise above the desired value up to and past the limit value. In practice, said means consists of a contrast fluid, which is initially transparent and preserves the transparency thereof during temperature reduction past said limit value and said desired value, but is converted to an irreversible opaque state if the temperature would increase above the desired value. In WO 01/72601, it is disclosed how the temperature indicator in question may be applied to the outside of a bar-code exposed on the external surface of the package in order to at least partially cover the same. The intention with this is that the temperature indicator in the transparent state thereof should enable scanning of the code, but in a triggered, opaque state make conventional scanning of the code impossible. During the development of the temperature indicator which is the subject of WO 01/72601, it has, however, turned out that the normal scanning of the bar-code, i.e. scanning of fully useful goods on the packages of which the temperature indicator has not been triggered, is made more difficult in spite of the medium in the temperature indicator still being transparent.

Bar-codes of the type that are applied to packages for food and other merchandise usually consist of so-called EAN codes, where the letters EAN stand for European Article Number. This constitutes a worldwide system for article numbering of all types of consumer goods. The system is administered by “International Article Numbering Association, EAN”, which issues instructions for the users which are associated to the system. EAN is used in shops having computerized paydesks and a fixed or mobile bar-code scanner. When the symbol is scanned, a registration of the EAN code takes place in the computer system of the shop. The most common bar-codes consist of price codes and weight codes, respectively. When the registration takes place a row of measures are triggered, if a code is in the price memory of the computer system. The price and the merchandise description, which the shop has entered into the computer system, are shown for the customer through a price window. The information is printed in plain text on the receipt of the customer, and the computer adds the amount to be paid. On possible price changes, the goods does not have to be remarked. Furthermore, by using special programs in the computer system, there is a possibility to effectively assemble information, which may be combined in order to form a basis for order quantities, composition of class of goods, pricing, etc. The system could also be utilized for registering whether frozen goods has thawed, namely if the packages of the goods are provided with temperature indicators, which are combined with the bar-code of the packages. However, a condition for a scanning and computer system of a shop to be used in practice, is that the symbol scanning and registration becomes reliable, quick and correct. If a covering temperature indicator would delay the symbol scanning operation, e.g. by causing repeated re-scans, the possibility becomes less interesting.

In this connection, it should be pointed out that the code scanners on the market make use of infrared light, which illuminates the bars as well as the intermediate neutral fields in a bar-code, the contrast between the bars and said fields being crucial for the quality of scanning. In larger scanners the bars are illuminated by a grid of light rays. If the bars are of a dark colour, such as black or blue, at the same time as the neutral fields are light, e.g. white or yellow, an optimum contrasting effect is obtained. However, also other combinations of colour may exist. The essential thing is that the infrared light is either absorbed or reflected by the colours in question. Of large importance is naturally also the distinctness of the code bars.

### OBJECTS AND FEATURES OF THE INVENTION

The present invention aims at obviating the code scanning problems that are associated with the package according to WO 01/72601 and at providing an improved package. Thus, a primary object of the invention, in a first aspect, is to provide a package for goods having a bar-code as well as a temperature indicator, which can separate saleable goods from obsolete without aggravating the scanning of a bar-code by means of a conventional, existing scanning equipment. This object is attained by the features defined in the characterizing clause of claim 1. Preferred embodiments of the package are furthermore defined in the dependent claims 2-8.

In a second aspect, the invention also aims at providing a method for marking packages for goods. The features of this method are seen in claims 9 and 10.

### FURTHER ELUCIDATION OF PRIOR ART

By DE 19912529, a temperature indicator is previously known in the form of a label applicable on packages for goods, which in addition to a thermally reactable layer having a variable colour, includes a transparent top coat in which a bar-code is integrated. As long as the goods in question keeps the desired temperature, the reactable layer remains unaffected and the bar-code scannable, but if the desired temperature is exceeded, the lower layer changes its colour and makes the bar-code unscannable. However, a disadvantage of this label is that the same is intended to form the individual price or weight code of the package for goods, which means that an extremely large number of different labels have to be manufactured, distributed, stored and applied to the thousands different goods, which are in circulation in the convenience goods trade and which demand individual code marking.

### SUMMARY OF THE INVENTION

The present invention is based on the understanding that for the scanning of a bar-code, not only neutral fields between nearby bars in the code or the symbol is required, but also fairly wide, neutral fields beside the bar-code, i.e. outside the two outer bars. By placing the temperature indicator beside the bar-code, although in close connection to one of the outer code bars thereof, it is guaranteed that the temperature indicator cannot disturb the scanning by entirely or partly overlapping the bar-code. As long as the temperature indicator is more or less distanced from the bar-code, a distinct contrasting effect is always obtained between the bars and the untriggered temperature indicator at normal scanning of saleable goods.

### BRIEF DESCRIPTION OF THE APPENDED DRAWINGS

In the drawings:

FIG. 1 is a perspective view of a package according to the invention, a temperature indicator being shown applied beside a bar-code on a long-side edge surface on the package,

FIG. 2 is an enlarged front view of the bar-code and the temperature indicator, the temperature indicator being shown in an initial state,

FIG. 3 is an analogous front view showing the same temperature indicator in a triggered state,

FIG. 4 is an exaggeratedly enlarged cross-section through a first embodiment of a temperature indicator according to the invention,

FIG. 5 is an analogous cross-section showing a second, alternative embodiment of the temperature indicator,

FIG. 6 is a chart showing the function of the temperature indicator in different temperature states,

FIG. 7 is a partially cut perspective view of an alternative embodiment of a temperature indicator shown in connection with a bar-code,

FIG. 8 is an enlarged longitudinal section through the temperature indicator according to FIG. 7 shown in an initial, unaffected state,

FIG. 9 is an analogous longitudinal section showing the temperature indicator in a primed state,

FIG. 10 is a perspective view of the bar-code and the temperature indicator, the last-mentioned one being shown in a triggered state,

FIG. 11 is a perspective view corresponding to FIG. 10 showing another, alternative embodiment of the temperature indicator,

FIG. 12 is a longitudinal section showing an additional alternative embodiment of a temperature indicator,

FIG. 13 is a chart illustrating the melting point for an olive oil,

FIGS. 14-16 are enlarged longitudinal sections through an additional alternative embodiment of a temperature indicator, which is shown in three different useful states, and

FIG. 17 is a perspective view of the temperature indicator according to FIGS. 14-16 in a finally, triggered state.

### DETAILED DESCRIPTION OF PREFERRED EMBODIMENTS OF THE INVENTION

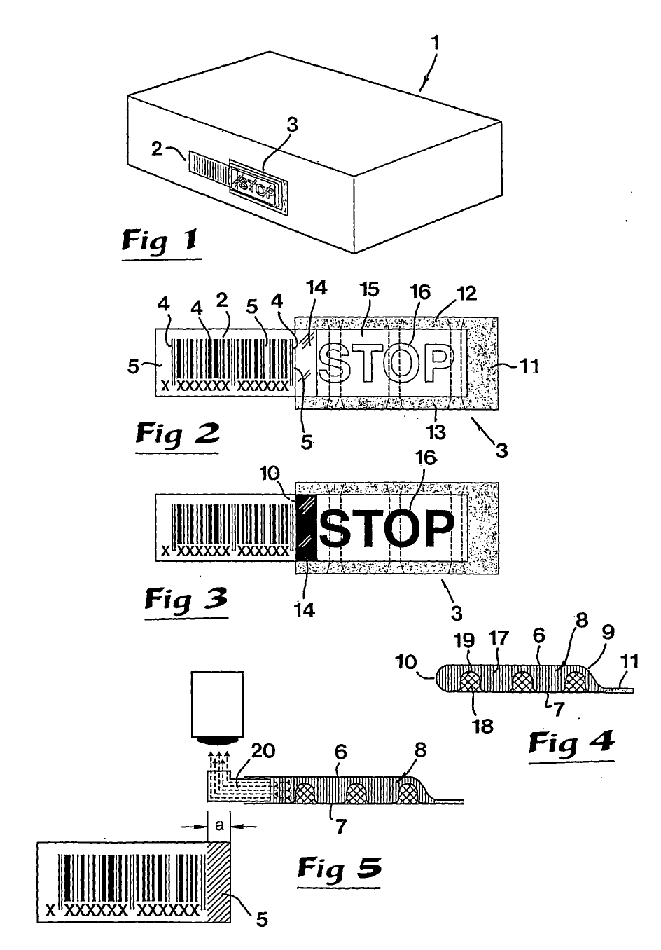

In FIG. 1, numeral 1 generally designates a package for goods, preferably in the form of a package for frozen goods, which in the example has a parallelepipedic, flat basic shape. In practice, the package may consist of a capsule of comparatively stiff board or cardboard. On one of the part surfaces of the package, in this case a long-side edge surface, a bar-code 2 as well as a temperature indicator 3 according to the invention are applied. The bar-code 2 may consist of a conventional price code and/or weight code (merchandise code), which may be printed on the package in connection with the same generally being provided with printing. Alternatively, the bar-code 2 may be included in a piece of tape, a label or the like, which is applied to the package afterwards. By scanning in an available code scanner, the bar-code enables the usual data capture in a computer system of a shop.

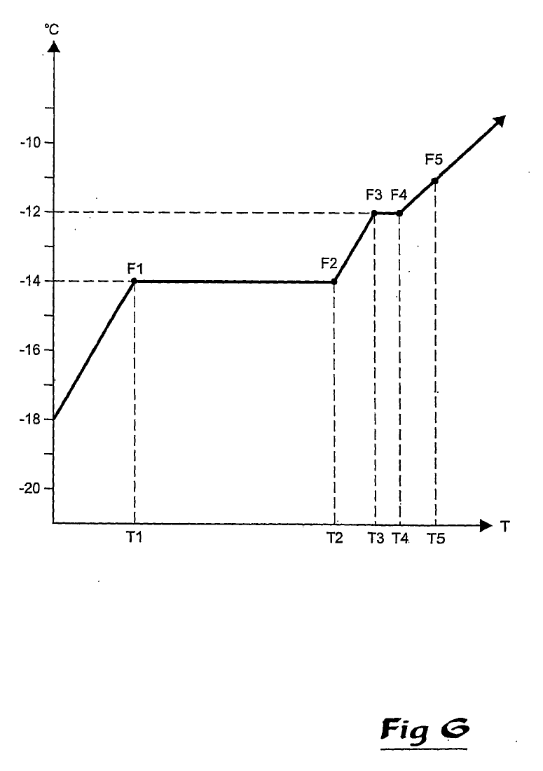

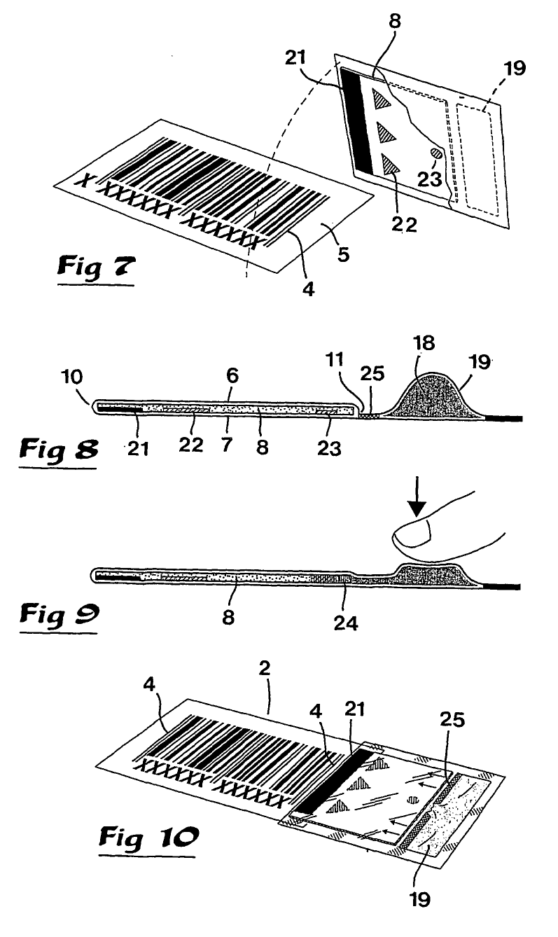

As is seen from the enlarged views of FIGS. 2 and 3, the bar-code 2 includes a plurality of code bars located between two outer bars 4 having mutually varying thickness and location. Together said code bars form an elongate, rectangular configuration. Under the code bars, there is usually also a numerical series of Arabic figures, which in the example are designated “X”. In the area outside the two outer code bars 4, neutral fields 5 without any text or pictures are left in order to enable scanning according to prevalent bar-code technique. In practice, said fields should have a width of at least 2.7 mm. The code bars 4 may have a black, blue or another dark colour, while the fields 5 positioned between and outside the code bars may have a white, yellow or another light colour. The essential thing in this connection is that a contrasting effect is attained by the infrared light of a code scanner either being absorbed or reflected by the different colours.

The temperature indicator, in its entirety designated 3, which is shown on an enlarged scale in FIGS. 2 and 3, has general similarities to the temperature indicator disclosed in WO 01/72601 inasmuch as it comprises a contrast medium generally designated 8 contained between a front wall 6 and a base wall 7, which has a certain colour or light-reflecting property in a first temperature state, and is arranged to be irreversibly converted to a different colour or light-reflecting property at transition to another temperature state. However, as will be seen below, the present temperature indicator has another a construction than the previously known indicator.

The two walls 6, 7 are included in an outer casing 9, which contains or confines the contrast medium 8, and which may by realized in the form of a label or label-like unit applicable on the outside of the package. Said label may have an elongate, rectangular basic shape, and be manufactured from a partially transparent film web, which is double-folded along a first short-side edge 10 and welded together at the other edges as is outlined at 11, 12 and 13. Thus, in the shown, rectangular embodiment, the film is welded along two long-side edges 12, 13, and the short-side edge 11 that is opposite the double-folded edge 10. The front wall 6 includes transparent as well as opaque fields. More precisely, a transparent, comparatively narrow field or window 14 is arranged adjacent to the edge 10, while the remaining surface is covered by or consists of an opaque field 15. In said opaque field 15, there are, however, also a number of transparent symbol fields 16, which in the example are in the form of letters (which together form the word STOP). On the back side of the base wall 7 that is applied against the surface of the package, there may advantageously be a layer of adhesive (not shown).

The front wall 6 should have a light, e.g. white or yellow, colour in order to reflect infrared light. For the same reason, the front side of the base wall 7 should have a light colour. Alternatively, the base wall may be transparent.

The contrast medium, in its entirety designated 8, includes in the example two different liquids, a first one of which is designated 17 and is denominated indicator liquid. The second liquid is designated 18 and is included in one or more burstable capsules 19, which at least partially are surrounded by the indicator liquid 17. The liquid 18 will henceforth be denominated henceforth phase-changing liquid. Characteristic of the liquids 17, 18 is, generally, that they have different freezing points or eutectic temperatures. At least one of the liquids, viz. the phase-changing liquid 18, contains water and one or more freezing-point lowering agents. In addition, the liquid 18 contains a colouring agent. Suitably, the liquids may consist of only water, although also alcohol could be included. According to a preferred embodiment of the invention, salt of the type that is approved for use in foods is used as a freezing point lowering agent. Advantageously, the agent in the respective liquid may consist of a mixture of at least two salts, such as chlorides and sulphates of calcium, potassium and sodium, respectively. Particularly, a mixture of sodium chloride (NaCl) and sodium sulphate (Na₂SO₄) is preferred, the eutectic temperatures of which in mixture with water can simply be established by varying the amount of salt in the water. Thus, in a mixture of H₂O, NaCl and Na₂SO₄, the eutectic temperature may be set with high accuracy within the:; temperature range of −1° C. to −21° C. The desired temperature value for quick-frozen foods is usually −18° C. In these circumstances, the eutectic temperature in the indicator liquid 17 may be set to −14° C., while the eutectic temperature for the phase-changing liquid 18 is set to the higher value −12° C.

In the same way as in the known temperature indicator according to WO 01/72601, the outer casing 9 is made of a material, which resists low temperatures without becoming brittle or otherwise degradable. Simultaneously, the burstable casing/casings or inner envelope/envelopes 19 are made of a film material that preserves a fundamental elasticity or softness at degrees above zero, but becomes brittle and degradable at lower temperatures. When a goods contained in the package 1 is frozen down, the following takes place in the temperature indicator: As the temperature falls from room temperature, heat is transported from the liquids 17, 18 via the respective casings out into the cooled environment. When the temperature in the phase-changing liquid 18 falls, the volume of the liquid decreases at the same time as the volume of the individual casing 19 decreases, the material therein becoming more brittle. When the temperature has fallen to −12° C., the liquid 18 freezes to ice and begins to expand. Somewhat later (at −14° C.), also the liquid 17 begins to freeze to ice and to expand. When the ice expands inside the capsules 19, the capsules crack, whereby an irreversible communication path to the ice/liquid 17 arises. The ice formed by the indicator liquid 17 can expand without the outer casing 9 being damaged or effected, since the material in said casing preserves the softness and tightness thereof at considerably lower temperature than the capsules 19. On this occasion, i.e. as long as the temperature is below −12° C., no reaction takes place between the liquids 17, 18 because the same are in the state of ice. The temperature indicator is now primed.

If the temperature indicator 3 on a later occasion would unintentionally come to be thawed, by being exposed for temperatures above −12° C. during a considerable time, initially the ice mass 17 and then the ice mass 18 will melt and revert to the liquid state. By the fact that the capsules 19 have cracked at the freezing occasion, the liquid 18 can leak out into the liquid 17 and colour the same, because the liquid 18 contains a colouring agent. Said colouring agent may in practice consist of pigments, e.g. pigment of the type that is approved for use in food. It is also feasible to provide the requisite colouring of the liquid 17 by a chemical reaction between the liquids. Thus, the initially transparent state of the liquid 17 is altered, in a known way per se, to an opaque, dark coloured state. This change of state is not reversible and will subsist also if the package and the content thereof are frozen down again.

The described course of thawing is illustrated graphically in FIG. 6, the presumptions being that the indicator liquid has a freezing point of −14° C. and the phase-changing liquid 18 a freezing point of −12° C. On thawing, the temperature in the indicator will increase linearly from −18° C. to −14° C. during the time T1 up to phase F1. The indicator then contains only ice. During the time T2, the outer ice mass 17 melts to liquid, and during this time, the temperature is constantly −14° C. up to phase F2. Then the temperature rises linearly to −12° C. during the time T3 up to phase F3. During the time T4, the ice mass in the capsules melts and the temperature indicator begins to change colour during phase F4. In a fifth phase F5, the entire content of the temperature indicator has melted to liquid, the indicator being triggered inasmuch s the indicator liquid has been coloured.

If the temperature indicator would be exposed to a temperature rise up to the phase F3, and then be frozen again to a temperature below −14° C., the indicator will return to an untriggered, uncoloured state. If the exposure passes the phase F3, the indicator will entirely or partly be triggered depending on how far the phases F4 and F5 are driven.

In practice, it should be ensured that the volume of the phase-changing liquid 18 is considerably smaller than the volume of the indicator liquid 17. In this way, it can be guaranteed that the capsules in the untriggered state do not become ocularly perceptible, in particular if they have the same colour or light-reflecting property as the rest of the base wall. It is also feasible to place the capsules outside the rectangular transparent fields 14, 16. However, after triggering the coloured, dark liquid 17 will distinctly appear via the transparent fields 14, 16. This results in scanning of the bar-code 2 being prevented, because the surface section 14 covers the neutral, light field 5 outside the outer code bar 4. Since said area, after triggering of the temperature indicator, has become dark, the prevalent bar-code technique makes scanning impossible. At the same time, the human eye can observe that the goods has become obsolete by thawing, in that a warning symbol in the form of the word STOP clearly appears in the front wall of the temperature indicator, as is shown in FIG. 3.

As long as the temperature indicator is primed, but not triggered, as shown in FIG. 2, conventional code scanning may be carried out without in any respect being made more difficult, because the temperature indicator does not in any place cover the bar-code.

In FIG. 5, an alternative embodiment of the temperature indicator is shown according to which an optical fibre element 20 is arranged at the edge of the indicator that is turned to the bar-code. This optical fibre element is transparent or light-reflecting as long as the contrast medium 8 is transparent or light-reflecting, but on triggering of the indicator the same becomes opaque or light-absorbing in order to make a scanning of the bar-code impossible by covering the field 5.

In practice, the temperature indicator should be placed with the short-side edge thereof within a distance of 0-3 mm, suitably 0.2-2.0 mm from the outer code bar 4 of the bar-code 2.

### Alternative Embodiments of the Invention

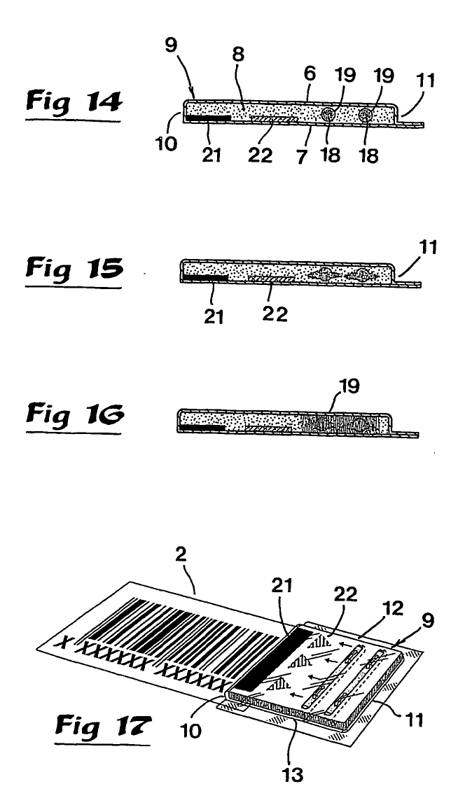

Reference is now made to FIGS. 14-17, which illustrate an additional embodiment of a temperature indicator. Also this embodiment is intended for temperature or saleability supervision of deep-frozen goods.

In the example, the temperature indicator has the form of a label having an exposed, visible front wall 6 and a hidden bottom side 7 in the applied state, which advantageously may include an adhesive (not shown) by means of which the label may be sticked onto the package 1. In practice, the label may be in the form of a casing 9 made from a thin plastic foil or plastic film, which is folded along an end edge 10 and welded together along two long-side edges 12, 13 and an opposite end edge 11. Said plastic film may have a front wall 6, which is either transparent in its entirety, or formed with transparent windows surrounded by opaque fields. The film defines a hollow space which houses a porous, capillary suctioning means 8, e.g. in the form of a strip of paper or the like, which forms the contrast medium of the indicator. In other words, the film forms a casing which surrounds the strip, preferably in such a way that the casing is in close contact with the outside of the strip.

Furthermore, inside the casing 9, at least one capsule is arranged which contains a liquid. In the shown, preferred embodiment, two such capsules 19 are present, which are placed fairly near each other in the area of the end edge 11 of the label. Each individual capsule is manufactured from a thin film of a material, e.g. a suitable plastic, which retains a fundamental elasticity or softness at a certain temperature, e.g. near 0° C., but becomes brittle at lower temperatures, e.g. below −16° C. The liquid designated 18 contained in the individual capsule may, for instance, consist of a mixture of alcohol and water in such proportions that the freezing point of the liquid mix is at, for instance, −16° C.. Such a liquid mix is colourless and transparent.

Experiments that form the basis of the invention have shown that paper has different optical properties in dry and wet states, respectively. More precisely, the top side of a white or brightly coloured paper is in a dry state opaque so far that only the surface, but not the interior of the paper fibre web may be seen by the eye. However, as soon as the fibre web becomes wet, the same becomes transparent inasmuch as at least the outermost layer of the fibre web may be seen through. This phenomenon may, in the invention, be utilized in such a way that the strip 8 is provided with one or more prints, which are invisible from the top side as long as the strip is dry, but which are made visible when the strip becomes wet. Although the number of prints as well as the physical shape and location thereof in the fibre web, may be varied in a multiple of ways within the scope of the invention, two different prints 21, 22 are shown in the example according to FIGS. 14-17, which are applied onto the back or bottom side of the strip 8. In this connection, it should be reminded that the top side of the strip is covered by the transparent plastic film, and is therefore always visible for the eye, while the back side of the strip is turned towards the package 1 and, therefore, not exposed in the direction of the observer (if the front wall is partially transparent via windows corresponding to the prints 21, 22 only the parts of the top side, which are under the windows, are of course seen). The print 21, which is located in the immediate vicinity of the end edge 10, consists of a border that extends along the major part of the width of the label, while the print 22 consists of a number of warning triangles. The different prints may advantageously have different colours that, however, always should deviate from the colour of the strip 8. The same may advantageously be white or at least light in order to reflect infrared light of the type that is used in code scanners. The colours of the prints 21, 22 should generally be darker than the white or the light colour of the strip 8. Advantageously, the colour of the print 21 may be black, while the triangular prints 22 may be of, for instance, yellow, red or orange colour.

Although series manufacturing of the label can be carried out in various ways, the print-carrying strip 8 should be pre-printed on one side thereof, and then it is contained in a double-folded plastic film, which is welded along three edges. Before sealing the plastic film, the liquid capsules 19 are also inserted either by beforehand being inserted in the strip (e.g. in countersinks in the same), or by being placed between the strip and the surrounding casing 9.

Arbitrarily long time after the manufacture, the disclosed temperature indicator/the label may be primed for use, more precisely on the occasion when a storing period for a packaged frozen goods should be initiated. The only essential in this connection, is that the label before priming is not exposed to temperatures below the limit value that should be supervised (e.g. −16° C.). Conventionally, freezing of frozen goods is carried out at very low temperatures in order to hasten the freezing process. Inside the temperature indicator, the following then takes place: As the temperature falls from the room temperature, heat is transported from the liquid capsules via the casing to the cooled surroundings. When the temperature has fallen to, for instance, −16° C., the liquid 18 in the capsules freezes to ice and begins to expand. Simultaneously, the material in the capsule walls has become brittle, said expansion resulting in that the capsules burst (in practice cracks are formed in the capsule walls). The bursting means that an irreversible path of communication is established between the interior of the capsules and the surrounding paper fibre web. However, as long as the temperature is below said limit value, no exit of liquid from the capsules takes place, because the liquid still exists in a solid state, more precisely as ice. The temperature indicator is now primed.

However, if the package 1 together with the temperature indicator 3 thereof, at some occasion during the handling from the producer to the consumer would come to be thawed by being exposed to temperatures above the limit value during a considerable time, the ice will melt and return to the liquid state. The accordingly triggered liquid (see FIG. 15) is first sucked into the fibre web in the immediate vicinity of the capsules 19 (see FIG. 16), and then continued capillary suction implies that the strip is wet in its entirety, as is shown in FIG. 17. In this connection, the strip becomes transparent so that the two prints 21, 22 appear from the outside of the label.

The invention is applicable not only to such packages that contain frozen foods. Below, a summary will follow of a number of alternative embodiments, which are particularly suitable for the saleability supervision of chilled goods, i.e. goods which are stored at temperatures below room temperature, but above the freezing point, e.g. at +4° C. or +8° C..

In an alternative embodiment according to FIGS. 7-9 particularly suited for chilled products, a liquid that has a semi-plastic consistency at temperatures below a certain limit value, but becomes liquid at temperatures above the same, is used as a wetting agent. For chilled products in general and chilled foods in particular, the chosen limit value should be in the temperature range of 0 to +12° C., suitably between +2° C. and +10° C. For specific foods, the limit value may be established to either +4° C. or +8° C.

Because the liquid in question should have the ability to transform or be converted from one viscosity state to another, more precisely between on one hand, a state of low viscosity, and, on the other hand, a semi-plastic or probably a state of high viscosity—depending on the ambient temperature—said liquid henceforth will be denominated conversion liquid.

The choice of conversion liquid is determined by a plurality of factors, one of which is the nature of the packaged goods. Thus, if the product consists of a food, a liquid that is not toxic and/or chemically active should be chosen. Therefore, for the purpose, vegetable or animal oils are suitable of the type that has a melting point or a viscosity transition temperature within the range of 0-12° C. Experiments which form the basis of the present invention have shown that olive oil is particularly appropriate. Therefore, a brief account of a practical experiment will follow below, reference being made to the chart in FIG. 13.

An olive oil of the mark “BERTOLLI GENTILE, Extra Vergine” was cooled down in a refrigerator to a temperature of +3° C., and then the sample was taken out in room temperature for measurement of the temperature change as well as the consistency of the oil, once per minute during totally 6 minutes. Below the result of these measurements follows in tabular form.

| Time | Temperature | |
|---|---|---|
| (minutes) | (° C.) | Consistency |
| 0 | +3.4 | Semi-plastic, honey-like |
| 1 | +4.5 | Semi-plastic, honey-like |
| 2 | +6.0 | Indication of liquefaction |
| 3 | +7.5 | Liquefaction initiated |
| 4 | +8.6 | Viscous |
| 5 | +9.8 | Of low viscosity |
| 6 | +10.3 | Of low viscosity |

Thus, during the relatively narrow temperature interval of 2.6° C. between +6.0° C. and +8.6° C., the olive oil in question transforms from a non flowing, semi-plastic state to a state, which above +8.6° C. becomes of low viscosity.

In the example according to FIGS. 7-9, a conversion liquid 18 of the above described type is contained in a capsule 19, which is connected to the label via a welded material portion 25 in which one or more weakened portions are included that may form an open way of communication between the capsule and the strip 8. In this case, the strip 8 has three prints 21, 22 and 23 on the bottom side thereof. In this case priming takes place by a mechanical pressure being applied against the capsule 19. Said pressure may be provided either in a manual way, e.g. by means of fingers, or in a mechanical way by means of the tool, which is used in order to apply the label on the package. When the liquid pressure in the capsule is raised sufficiently high, the weakened material portion in the welding 23 serving as a valve, breaks, whereby a free way of communication is established for the liquid up to the strip. By initially executing the priming in an environment where the ambient temperature is below the limit value that is determined by the melting point of the liquid (e.g. +4° C.), it is, however, guaranteed that the liquid is not immediately sucked into the strip 8 in its entirety. Thus, the still semi-plastic liquid will only reach the end of the strip. In practice, the capsule 19 is punctured earliest in connection with the indicator being applied to the package 1 and/or the goods being brought into a cooling accomodation, for instance at a manufacturer/distributor or in a shop. In this state, the strip 8 is unaffected by the liquid. In other words, the prints 21, 22, 23 are still hidden under the surface layer turned outwards of the paper fibre web.

Suppose that the temperature limit value in question for the goods is set to +4° C. As long as the ambient temperature is below the same value, the label remains in the initial state thereof. If, however, the temperature during storing of the goods would exceed +4° C., the consistency of the liquid will be converted from a semi-plastic one to a liquid one. By the capillary effect in the porous strip 8, the liquid will then be sucked into the strip and completely wet the same, the prints 23, 22, 21 appearing and becoming visible from the outside of the label. In this way, the observer is made aware of the fact that the temperature limit value has been exceeded.

According to the invention, also the label according to FIGS. 7-9 is applied in the immediate vicinity of the bar-code 2 of the package 1. More precisely, the label is placed with the end edge 10 thereof in the immediate vicinity of an outer code bar 4. In practice, the dark, border-like print 21 of the label should be located at a distance within the range of 0.2-2.0 mm from the outer code bar 4 of the bar-code. In this way, it is guaranteed that conventional code scanning without hindrance can be carried out as long as the strip is dry and white/light, but as soon as the strip is wet the dark border 21 appears and makes impossible scanning of the code, because the border absorbs the infrared light of the code scanner.

The embodiment shown in FIG. 11 differs from the preceding embodiment only in that the print 22 is in the form of a comparatively large triangle, which has the purpose of making visible the successive penetration of the liquid in the paper strip. As is outlined in FIG. 11, said triangle may include two or more fields, which may have different colours.

In FIG. 12, an additional alternative embodiment is shown, in which a contraction 26 is included, where the material in the paper strip 8 is compressed. In this way, penetration of the liquid in the direction towards the end 10 is delayed or counteracted.

A delay of the penetration of the liquid of low viscosity in the fibre web may also be provided by making the fibre web with spaced-apart sections, which have different porosity or varying capillary effect. By delaying the liquid penetration in a suitable way, it is guaranteed that the article has to be exposed to a harmfully increased temperature during a certain time in order to trigger the indicator. A short exceeding of the temperature limit value, e.g. during the time which the customer stays in a shop (usually maximum approximatively 30 min), will therefore not lead to a triggering of the indicator.

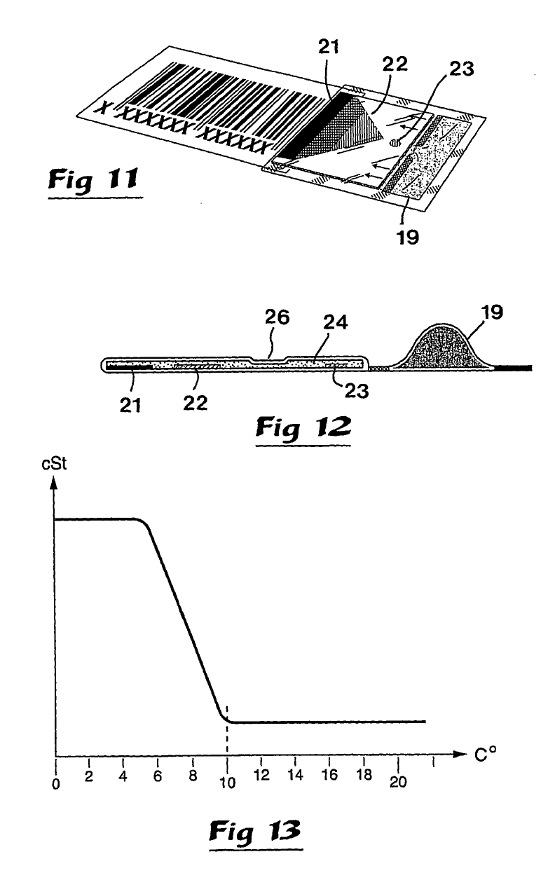

It is given that a semi-plastic conversion liquid of the type that has been described above in connection with FIGS. 7-12 may also be used in capsules of the type that are integrated in the fibre web in the way shown in FIGS. 14-17. It is even feasible to have, in a combination, a semi-plastic conversion liquid in one capsule, and a freezing liquid (e.g. water/alcohol) in another one.

### FEASIBLE MODIFICATIONS OF THE INVENTION

The invention is not solely limited to the embodiments described above and illustrated in the drawings. In the packages may, for instance, medicines, photographic films, etc, be stored. Furthermore, it is feasible to utilize the temperature indicator according to the invention in order to detect/register whether freezing rather than thawing has taken place. Thus, in practice, the temperature indicator could be utilized on pots for paint. Paint is frequently water-based and thereby affected by freezing. If a temperature indicator is applied, for instance, on the outside of a lid, it will indicate if the container/package has been exposed to unallowed temperatures. This takes place by the phase-changing liquid in the temperature indicator freezing and bursting, and colouring the indicator liquid, if the temperature is lowered below an allowed value from 0° C. and downwards. Furthermore, the front wall 6 exposed outwards, may be thicker than the base wall 7 so as to obtain a greater heat insulation capacity than the base wall. By said increased heat insulation capacity, it is attained that the temperature in the indicator liquid does not immediately rise already as a consequence of a short contact between the temperature indicator and a hand that seizes the package. Furthermore, the temperature indicator may include a varying number of capsules having a phase-changing liquid. In this connection, it should also be mentioned that the storage and the delimitation of the phase-changing liquid in relation to the indicator liquid may be realized in many other ways, e.g. by the phase-changing liquid being encapsulated in a plurality of small, mutually spaced-apart balls or bubbles.

Within the scope of the invention, it is furthermore feasible to provide the front and base walls, which liquid-tightly contain the contrast medium in another way than in the form of parts of a continuous casing of plastic film. Thus, if the contrast medium consists of a wettable paper strip or fibre web, it is possible to coat (t ex spray) the surfaces of the strip with a particle-shaped material, which may form a liquidtight film. Although EAN codes are the most common form of merchandise codes, in particular for food, the invention is also applicable in connection with other types of merchandise codes, which make use of bars or bar-like symbols. Examples on such codes are Interleaved 2/5, Code 39, Code 128, as well as PDF-417. Characteristic of these codes too, is that the bars or the symbols form a rectangular configuration in the extension of which a temperature indicator can be applied.

1. A package for storing goods in a preservative state in which the temperature may not pass a certain limit value, comprising, on one hand, a bar-code (2) of the type that between two outer, light-absorbing code bars (4), includes a plurality of intermediate and likewise light-absorbing code bars or marks (4) mutually spaced-apart by neutral, light-reflecting fields (5), outer, neutral fields (5) being found also outside the outer code bars, and on the other hand a temperature indicator (3), which comprises a contrast medium (8) contained between a front wall (6) and a base wall (7), which medium in a first temperature state is transparent or light-reflecting, but which on transition to another temperature state is triggered so far that the same is irreversibly converted to an opaque or light-absorbing colour, characterized in that the temperature indicator (3) is located beside the bar-code (2) in close vicinity of one of the outer code bars (4) thereof without covering the bar-code, in order to, on one hand, in the first temperature state thereof without hindrance enable scanning of the bar-code, but on the other hand, after triggering, make scanning impossible, more precisely by making an outer, neutral field (5) opaque or light-absorbing.

2. A package according to claim 1, characterized in that the temperature indicator (3) consists of a separate, label-like unit applied to the outside of the package (1).

3. A package according to claim 1, characterized in that the two walls (6, 7) of the temperature indicator (3) are included in a continuous and at least partly transparent film web (9), which is double-folded along an edge (10), which is situated closest to an outer code bar (4) in the bar-code (2).

4. A package according to claim 2, characterized in that the label unit has an elongate, rectangular basic shape, the double-folded film edge consisting of a first short side edge (10), and that the two walls (6, 7) are inter-connected along two long-side edges (12, 13) and the second short side edge (11).

5. A package according to claim 2, characterized in that the temperature indicator (3), along an edge turned against the bar-code (2), includes an optical fibre element (20), which is transparent or light-reflecting as long as the contrast medium is transparent or light-reflecting, but which is made opaque or light-absorbing when the temperature indicator is triggered.

6. A package according to any one of the preceding claims claim 1, characterized in that the temperature indicator (3) is located with one edge (10) thereof within a distance of 0-3 mm, suitably 0.2-2.0 mm, from an outer code bar (4).

7. A package according to any one of the preceding claims claim 1, characterized in that the front wall (6) of the temperature indicator comprises a transparent field (14) in connection with an edge, as well as an opaque field (15) in which there is one or more secondary, transparent symbol fields (16), which have the purpose of visually indicating that the temperature indicator has been triggered by an alteration reaction in the contrast medium (8).

8. A package according to claim 1, characterized in that the contrast medium of the temperature indicator consists of a porous, capillary sucking means (8), which has a certain optic property in a dry state and another one in a state wet by a liquid (18).

9. A method for marking a package (1) for storing goods in a preservative state in which the temperature may not pass a certain limit value, comprising the steps of providing the package with a bar-code (2) of the type that between two outer, light-absorbing code bars (4) includes a plurality of intermediate and likewise light-absorbing code bars (4) mutually spaced-apart by neutral light-reflecting fields (5), outer, neutral fields (5) being left outside the outer code bars, and of applying a temperature indicator (3), which comprises a contrast medium (8) contained between a front wall (6) and a base wall (7), said medium being transparent or light-reflecting in a first temperature state, but which on transition to a predetermined second temperature state is triggered so far that the same in an irreversible way is converted to an opaque or light-absorbing colour, characterized in that the temperature indicator (3) is placed beside the bar-code (2) in close vicinity of one of the outer code bars (4) thereof without covering :the bar-code.

10. A method according to claim 9, characterized in that the temperature indicator (3) is placed with one edge (10) thereof within a distance of 0-3 mm, suitably 0.2-2.0 mm, from an outer code bar (4).

11. A package according to claim 2, characterized in that the two walls (6, 7) of the temperature indicator (3) are included in a continuous and at least partly transparent film web (9), which is double-folded along an edge (10), which is situated closest to an outer code bar (4) in the bar-code (2).

12. A package according to claim 3, characterized in that the label unit has an elongate, rectangular basic shape, the double-folded film edge consisting of a first short side edge (10), and that the two walls (6, 7) are inter-connected along two long-side edges (12, 13) and the second short side edge (11).

13. A package according to claim 3, characterized in that the temperature indicator (3), along an edge turned against the bar-code (2), includes an optical fibre element (20), which is transparent or light-reflecting as long as the contrast medium is transparent or light-reflecting, but which is made opaque or light-absorbing when the temperature indicator is triggered.
